(19) United States
(12) Patent Application Publication
(10) Pub. No.: US 2021/0266031 A1
(43) Pub. Date: Aug. 26, 2021

(54) Radio Frequency Integrated Module Management System

(71) Applicant: Jiedong Zhong, Guangdong (CN)

(72) Inventor: Jiedong Zhong, Guangdong (CN)

(21) Appl. No.: 16/867,591

(22) Filed: May 6, 2020

(30) Foreign Application Priority Data
Feb. 20, 2020 (CN) 202010107076.X

(51) Int. Cl. H04B 1/405; H04B 1/3805; H04B 1/3816

(52) U.S. Cl. CPC H04B 1/405; H04B 1/3816; H04B 1/3805

(57) ABSTRACT

The present disclosure provides a radio frequency integrated module management system. The radio frequency integrated module management system comprises a ZJD chip and at least two groups of radio frequency module systems. Each group of the radio frequency module systems is connected to the ZJD chip and comprises an antenna, a radio frequency front end, and a radio frequency transceiver. The antenna is connected to the radio frequency transceiver via the radio frequency front end, and the radio frequency transceiver in each group is connected to the ZJD chip.

### CROSS REFERENCE TO RELATED APPLICATIONS

The present application claims the benefit of Chinese Patent Application No. 202010107076.X filed on Feb. 20, 2020, the contents of which are incorporated herein by reference in their entirety.

### TECHNICAL FIELD

The present disclosure relates to the field of wireless communication, and more particularly to a radio frequency integrated module management system.

### BACKGROUND

At present, the RF module system in the device terminal is a single transceiver, which is composed of RF transceiver, RF front-end and antenna. RF module system maintains a data signal channel to communicate with the outside world. With the progress and development of modern science and technology, the unitary radio frequency module system has been unable to meet the needs of people's multiple tasks. The unitary radio frequency module system leads to low production efficiency and high production cost. The development of new radio frequency integrated module system can increase the production efficiency and save production cost, and make the device terminal innovate more technical application scenarios and accept multiple work tasks at the same time. However, such a system has not been developed under traditional technology.

### SUMMARY

All examples and features mentioned below may be combined in any technically possible way.

Implementations disclosed herein include a radio frequency integrated module management system, which is provided in a device terminal and comprises a ZJD chip and at least two groups of radio frequency module systems, each group of the radio frequency module systems being connected to the ZJD chip and comprising an antenna, a radio frequency front end, and a radio frequency transceiver, wherein the antenna is connected to the radio frequency transceiver via the radio frequency front end, and the radio frequency transceiver in each group is connected to the ZJD chip.

In some embodiments, the radio frequency integrated module management system comprises a main processor, a power system, and a baseband chip, wherein the ZJD chip is connected to the main processor and controlled by a signal of the main processor, the power system is connected to the ZJD chip and configured to provide external power supply for the ZJD chip, and the baseband chip is connected to the ZJD chip and configured for management and control of dedicated data signal channels between all of the radio frequency module systems and the baseband chip.

In some embodiments, the radio frequency integrated module management system comprise the ZJD chip manages and controls the dedicated data signal channels between all of the radio frequency module systems and the baseband chip; and the ZJD chip sets an independent dedicated data signal channel for each group of the radio frequency module systems and the baseband chip.

In some embodiments, an external data signal is transmitted through the antenna, received by an independent group of the radio frequency module systems and uploaded to the ZJD chip, then the ZJD chip asks for permission from the main processor, and if the main processor approves, the external data signal is transmitted, through a dedicated data signal channel set by the ZJD chip, to the baseband chip for data signal decoding, and if the main processor does not approve, the ZJD chip interrupts transmission of the external data signal.

In some embodiments, when the main processor sends a data signal, the main processor instructs the ZJD chip to receive encoding of the data signal from the baseband chip and transmit it to a designated radio frequency module system through a dedicated data signal channel, and then the data signal is transmitted through the antenna.

In some embodiments, any of the radio frequency integrated module management systems mentioned above includes a ZJD chip power supply module, wherein a ZJD chip power supply module is integrated inside the ZJD chip, and the ZJD chip power supply module is connected to each group of the radio frequency module systems and provides and manages a power supply service.

In some embodiments, the radio frequency module system in operation is in a full-power operation power supply mode, a next radio frequency module system waiting for an instruction is in a low-power standby power supply mode, and the radio frequency module systems except for the first radio frequency module system and the next radio frequency module system are in a power-off mode.

In some embodiments, when the device terminal is in standby, only a first group of radio frequency module systems are in the low-power standby power supply mode, and the other radio frequency module systems are in the power-off mode; when data signals need to be transmitted by the first group of radio frequency module systems, the first group of radio frequency module systems are switched from the low-power standby power supply mode to the full-power operation power supply mode, and a second group of radio frequency module systems are switched from the power-off mode to the low-power standby power supply mode; when data signals need to be transmitted by the second group of radio frequency module systems, the second group of radio frequency module systems are switched from the low-power standby power supply mode to the full-power operation power supply mode, and a third group of radio frequency module systems are switched from the power-off supply mode to the low-power standby power supply mode; and so on, such that an additive power supply mode is carried out.

In some embodiments, if a plurality of data signal channel transmissions are turned off, an operation opposite to an additive power supply mode is performed such that the radio frequency module systems which are turned off are switched from the full-power operation power supply mode to the low-power standby power supply mode, the radio frequency module systems in the low-power standby power supply mode are switched to the power-off mode, and so on, such that a subtractive power supply mode is carried out until only one group of the radio frequency module systems are in the low-power standby power supply mode.

In some embodiments, the device terminal is a fixed communication device terminal, a mobile communication device terminal, a fixed device terminal, a mobile device terminal, a mobile vehicle-mounted communication device terminal, an aircraft, or an aerospace communication device terminal.

### BRIEF DESCRIPTION OF THE DRAWINGS

In order to explain the embodiments of the disclosure or the technical solutions in the prior art more clearly, the following will give a brief introduction to the drawings needed in the embodiments or the prior art description. It is obvious that the drawings in the following description are only some embodiments of the disclosure. For those skilled in the art, without any creative work, they can also obtain other drawings in accordance with the described drawings.

FIG. 1 is a structural diagram of the radio frequency integrated module management system in accordance with one embodiment of the present disclosure;

FIG. 2 is a power supply diagram of the radio frequency integrated module management system in accordance with some embodiments of the present disclosure.

### DETAILED DESCRIPTION OF THE DISCLOSURE

The specific embodiments of the disclosure will be further described in combination with the appended drawings and embodiments. The following embodiments are only used to explain the technical solution of the disclosure more clearly and cannot limit the protection scope of the disclosure.

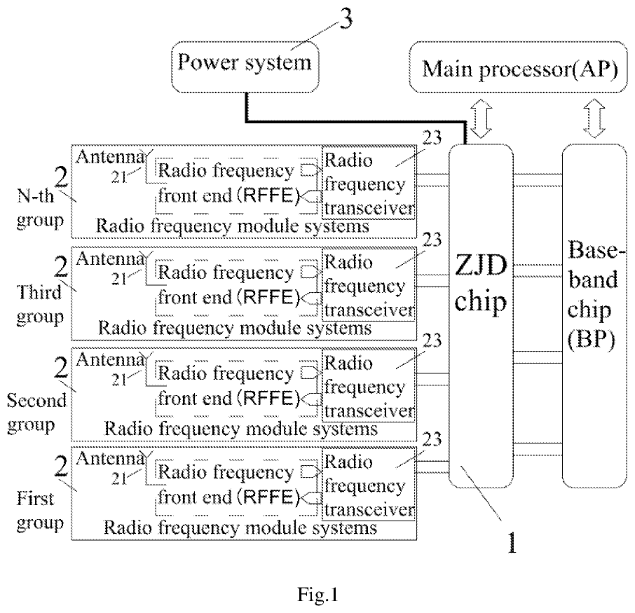

In the embodiments of the present disclosure, the radio frequency integrated module management system is provided in a device terminal. The device terminal is a fixed communication device terminal, a mobile communication device terminal, a fixed device terminal, a mobile device terminal, a mobile vehicle-mounted communication device terminal, an aircraft, or an aerospace communication device terminal. The structure of the radio frequency integrated module management system is shown in FIG. 1. In FIG. 1, the radio frequency integrated module management system comprises a ZJD chip 1 and at least two groups of radio frequency module systems 2. As an example, N group radio frequency module system 2 is drawn in FIG. 1. N is an integer greater than or equal to 2. In practical application, the size of N can be correspondingly increased or decreased according to the specific situation. For example, N can be 4, 5, 6, 7, etc. ZJD chip 1 is a self-developed chip.

Each group of the radio frequency module systems 2 are connected to the ZJD chip 1. Each group of the radio frequency module systems 2 comprises an antenna 21, a radio frequency front end RFFE, and a radio frequency transceiver 23. The antenna 21 is connected to the radio frequency transceiver 23 via the radio frequency front end RFFE, and the radio frequency transceiver in each group is connected to the ZJD chip. The present disclosure can meet the requirements of device terminal running two or more different data signals at the same time, improve multiple production efficiency, apply in device terminal innovatively, and innovate more technical application scenarios for device terminal.

In this embodiment, the radio frequency integrated module management system further comprises a main processor AP, a power system 3, and a baseband chip BP. The ZJD chip 1 is connected to the main processor AP and controlled by a signal of the main processor AP. The power system 3 is connected to the ZJD chip 1 and configured to provide external power supply for the ZJD chip 1. The baseband chip BP is connected to the ZJD chip 1 and configured for management and control of dedicated data signal channels between all of the radio frequency module systems 2 and the baseband chip BP. Under the control of the main processor AP, the device terminal has multiple groups of independent radio frequency module system 2 at the same time to communicate data signals through the dedicated channel between the ZJD chip 1 and the baseband chip BP. Under the control of the main processor AP, the device terminal can run a variety of different data signal communications at the same time, so as to meet the needs of people in the device terminal for multiple application work mode and multiple work tasks at the same time, and so as to create more technology application scenarios for device terminals.

The function of the ZJD chip 1 is to manage and control that all of the radio frequency module systems 2 and the baseband chip BP. The ZJD chip 1 sets an independent dedicated data signal channel for each group of the radio frequency module systems 2 and the baseband chip.

When an external data signal is transmitted through the antenna 21, received by an independent group of the radio frequency module systems 2 and uploaded to the ZJD chip 1, the ZJD chip 1 asks for permission from the main processor AP. If the main processor AP approves, the external data signal is transmitted, through a dedicated data signal channel set by the ZJD chip 1, to the baseband chip BP for data signal decoding. If the main processor does not approve, the ZJD chip 1 interrupts transmission of the external data signal.

When the main processor AP sends a data signal, the main processor AP instructs the ZJD chip 1 to receive encoding of the data signal from the baseband chip BP and transmit it to a designated radio frequency module system 2 through a dedicated data signal channel, and then the data signal is transmitted through the corresponding antenna 21.

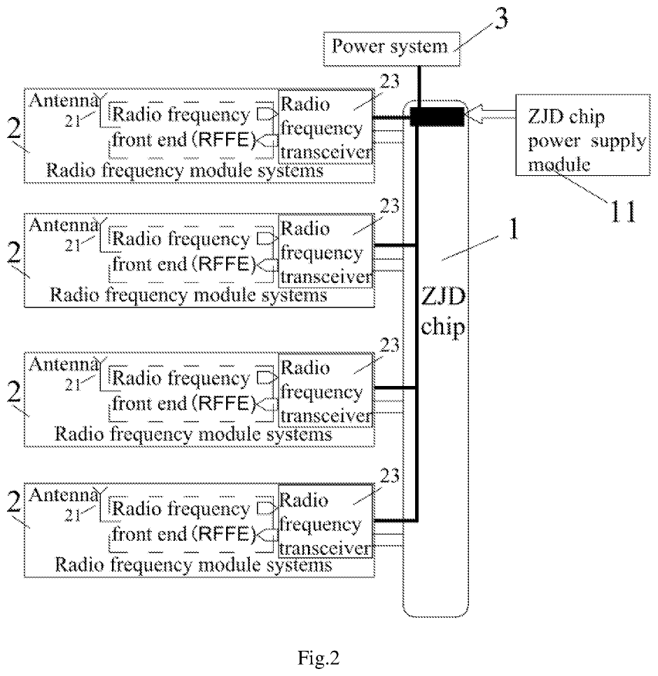

FIG. 2 is a power supply diagram of the radio frequency integrated module management system in accordance with some embodiments of the present disclosure. In FIG. 2, a ZJD chip power supply module 11 is integrated inside the ZJD chip 1. The ZJD chip power supply module 11 is provided with external power supply by external power system 3, and he ZJD chip power supply module 11 provides and manages a power supply service for each group of the radio frequency module systems 2.

The ZJD chip power supply module 11 adopts three power supply modes for radio frequency module system 2. The radio frequency module system 2 in operation is in a full-power operation power supply mode. A next radio frequency module system 2 waiting for an instruction is in a low-power standby power supply mode. And the radio frequency module systems 2 except for the first radio frequency module system 2 and the next radio frequency module system 2 are in a power-off mode.

Specially, when the device terminal is in standby, only a first group of radio frequency module systems 2 are in the low-power standby power supply mode, and the other radio frequency module systems 2 are in the power-off mode. When data signals need to be transmitted by the first group of radio frequency module systems 2, the first group of radio frequency module systems 2 are switched from the low-power standby power supply mode to the full-power operation power supply mode, and a second group of radio frequency module systems 2 are switched from the power-off mode to the low-power standby power supply mode. When data signals need to be transmitted by the second group of radio frequency module systems 2, the second group of radio frequency module systems 2 are switched from the low-power standby power supply mode to the full-power operation power supply mode, and a third group of radio frequency module systems are switched from the power-off supply mode to the low-power standby power supply mode; and so on, such that an additive power supply mode is carried out.

When the data signal transmission of an independent RF module system 2 is turned off, the power supply mode which is the opposite of the additive power supply mode is adopted, that is, the operation in the opposite direction is adopted. The radio frequency module systems 2 which are turned off are switched from the full-power operation power supply mode to the low-power standby power supply mode. The radio frequency module systems 2 in the low-power standby power supply mode are switched to the power-off mode, and so on, such that a subtractive power supply mode is carried out until only one group of the radio frequency module systems 2 are in the low-power standby power supply mode. In other words, until the data signal transmission of all independent radio frequency module systems 2 is turned off, one radio frequency module system 2 is reserved for small power standby power supply mode.

In summary, in this embodiment, the radio frequency integrated module management system is composed of the ZJD chip 1 and two or more groups of independent radio frequency module systems 2 (multiple antennas), so as to meet the requirements of device terminal running two or more different data signals at the same time. That is, under the control of the main processing AP, the device terminal has multiple groups of independent radio frequency module systems 2 at the same time. Through the control of the ZJD chip 1 control, device terminal carries out data signal communication independently with the baseband chip BP. Under the control of the main processing AP, the device terminal can run a variety of different data signal exchanges at the same time, so as to meet people's working modes and tasks of multi-user application at the device terminal at the same time. The present disclosure can improve multiple production efficiency, apply innovation to device terminals, and innovate more technical application scenarios for device terminals.

Some embodiments of the disclosure are described, but do not limit the disclosure. Any modification, equivalent replacement, improvement, etc. made within the spirit and principles of the disclosure shall be included in the protection scope of the disclosure.

What is claimed is:

1. A radio frequency integrated module management system, which is provided in a device terminal and comprises a ZJD chip and at least two groups of radio frequency module systems, each group of the radio frequency module systems being connected to the ZJD chip and comprising an antenna, a radio frequency front end, and a radio frequency transceiver, wherein the antenna is connected to the radio frequency transceiver via the radio frequency front end, and the radio frequency transceiver in each group is connected to the ZJD chip.

2. The radio frequency integrated module management system according to claim 1, further comprising a main processor, a power system, and a baseband chip, wherein the ZJD chip is connected to the main processor and controlled by a signal of the main processor, the power system is connected to the ZJD chip and configured to provide external power supply for the ZJD chip, and the baseband chip is connected to the ZJD chip and configured for management and control of dedicated data signal channels between all of the radio frequency module systems and the baseband chip.

3. The radio frequency integrated module management system according to claim 2, wherein the ZJD chip manages and controls the dedicated data signal channels between all of the radio frequency module systems and the baseband chip; and the ZJD chip sets an independent dedicated data signal channel for each group of the radio frequency module systems and the baseband chip.

4. The radio frequency integrated module management system according to claim 3, wherein an external data signal is transmitted through the antenna, received by an independent group of the radio frequency module systems and uploaded to the ZJD chip, then the ZJD chip asks for permission from the main processor, and if the main processor approves, the external data signal is transmitted, through a dedicated data signal channel set by the ZJD chip, to the baseband chip for data signal decoding, and if the main processor does not approve, the ZJD chip interrupts transmission of the external data signal.

5. The radio frequency integrated module management system according to claim 4, wherein when the main processor sends a data signal, the main processor instructs the ZJD chip to receive encoding of the data signal from the baseband chip and transmit it to a designated radio frequency module system through a dedicated data signal channel, and then the data signal is transmitted through the antenna.

6. The radio frequency integrated module management system according to claim 1, wherein a ZJD chip power supply module is integrated inside the ZJD chip, and the ZJD chip power supply module is connected to each group of the radio frequency module systems and provides and manages a power supply service.

7. The radio frequency integrated module management system according to claim 6, wherein the radio frequency module system in operation is in a full-power operation power supply mode, a next radio frequency module system waiting for an instruction is in a low-power standby power supply mode, and the radio frequency module systems except for the first radio frequency module system and the next radio frequency module system are in a power-off mode.

8. The radio frequency integrated module management system according to claim 7, wherein when the device terminal is in standby, only a first group of radio frequency module systems are in the low-power standby power supply mode, and the other radio frequency module systems are in the power-off mode; when data signals need to be transmitted by the first group of radio frequency module systems, the first group of radio frequency module systems are switched from the low-power standby power supply mode to the full-power operation power supply mode, and a second group of radio frequency module systems are switched from the power-off mode to the low-power standby power supply mode; when data signals need to be transmitted by the second group of radio frequency module systems, the second group of radio frequency module systems are switched from the low-power standby power supply mode to the full-power operation power supply mode, and a third group of radio frequency module systems are switched from the power-off supply mode to the low-power standby power supply mode; and so on, such that an additive power supply mode is carried out.

9. The radio frequency integrated module management system according to claim 7, wherein if a plurality of data signal channel transmissions are turned off, an operation opposite to an additive power supply mode is performed such that the radio frequency module systems which are turned off are switched from the full-power operation power supply mode to the low-power standby power supply mode, the radio frequency module systems in the low-power standby power supply mode are switched to the power-off mode, and so on, such that a subtractive power supply mode is carried out until only one group of the radio frequency module systems are in the low-power standby power supply mode.

10. The radio frequency integrated module management system according to claim 1, wherein the device terminal is a fixed communication device terminal, a mobile communication device terminal, a fixed device terminal, a mobile device terminal, a mobile vehicle-mounted communication device terminal, an aircraft, or an aerospace communication device terminal.
